(19) United States
(12) Patent Application Publication
(10) Pub. No.: US 2025/0342058 A1
(43) Pub. Date: Nov. 6, 2025

(54) Collective Scaling For Computing Environments

(71) Applicant: Dell Products L.P., Round Rock, TX (US)

(72) Inventors: Kean Nam Lim, Limerick (IE); Balakrishnan MV, Bangalore (IN)

(21) Appl. No.: 18/655,753

(22) Filed: May 6, 2024

(51) Int. Cl. G06F 9/50

(52) U.S. Cl. CPC G06F 9/5027

(57) ABSTRACT

Methods, apparatus, and processor-readable storage media for collective scaling for computing environments are provided herein. An example method includes evaluating whether a performance metric of a microservice in a feature group of a computing environment satisfies designated performance criteria, the feature group comprising interconnected microservices executing in the computing environment. In response to the performance metric satisfying the designated performance criteria, the method includes calculating a feature queue size for the feature group based on the performance metric, and determining, based on the calculated feature queue size and usage data related to one or more processing devices of the computing environment, computing resources to be allocated to the microservices in the feature group and one or more constraints for scaling the computing resources. The determined computing resources are allocated to the microservices in the feature group, and dynamically scaled based on at least one of the one or more constraints.

### BACKGROUND

Information processing systems increasingly utilize reconfigurable virtual resources to meet changing user needs in an efficient, flexible, and cost-effective manner. For example, cloud-based computing and storage systems implemented using virtual resources in the form of containers have been widely adopted.

### SUMMARY

Illustrative embodiments of the disclosure provide techniques for collective scaling for container-based environments. An exemplary computer-implemented method includes evaluating whether at least one performance metric of at least one microservice in a feature group of a computing environment satisfies one or more designated performance criteria, wherein the feature group comprises a plurality of interconnected microservices executing on one or more processing devices of the computing environment. The method also includes, in response to the at least one performance metric of the at least one microservice satisfying the one or more designated performance criteria, calculating a feature queue size for the feature group based at least part on the at least one performance metric of the at least one microservice, determining, based at least in part on the calculated feature queue size and usage data related to the one or more processing devices of the computing environment, computing resources to be allocated to the microservices in the feature group and one or more constraints for scaling the computing resources, allocating the determined computing resources to the microservices in the feature group, and dynamically scaling the allocated computing resources, by automatically adjusting an amount of the allocated computing resources of the computing environment, based on at least one of the one or more constraints.

Illustrative embodiments can provide significant advantages relative to conventional techniques. For example, technical problems associated with scaling interconnected microservices in computing environments (such as container-based computing environments) are mitigated in one or more embodiments using a collective scaling framework. In at least some embodiments, the collective scaling framework can initiate and scale workloads at the feature group level based on one or more performance metrics. Accordingly, services within a given feature group can be instantiated and scaled appropriately in response to changing resource demands, thus improving utilization of resources and reducing bottlenecks, for example.

These and other illustrative embodiments described herein include, without limitation, methods, apparatus, systems, and computer program products comprising processor-readable storage media.

### BRIEF DESCRIPTION OF THE DRAWINGS

FIG. 1 illustrates a computing environment within which one or more illustrative embodiments can be implemented.

FIG. 2 illustrates host devices and a storage system within which one or more illustrative embodiments can be implemented.

FIG. 3 illustrates a collective scaling architecture according to an illustrative embodiment.

FIG. 4 illustrates an example of a feature queue that is used for collectively scaling feature groups in an illustrative embodiment.

FIG. 5 shows a process flow diagram for scaling workloads, in an illustrative embodiment.

FIG. 6 shows a diagram of a machine learning model architecture in an illustrative embodiment.

FIG. 7 shows a diagram of an extended machine learning model architecture in an illustrative embodiment.

FIG. 8 shows a flow diagram of a process for collective scaling for computing environments in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

As the term is illustratively used herein, a container may be considered lightweight, stand-alone, executable software code that includes elements needed to execute the software code. A container-based structure has many advantages including, but not limited to, isolating the software code from its surroundings, and helping to reduce conflicts between different tenants or users running different software code on the same underlying infrastructure. The term “user” herein is intended to be broadly construed so as to encompass numerous arrangements of human, hardware, software or firmware entities, as well as combinations of such entities.

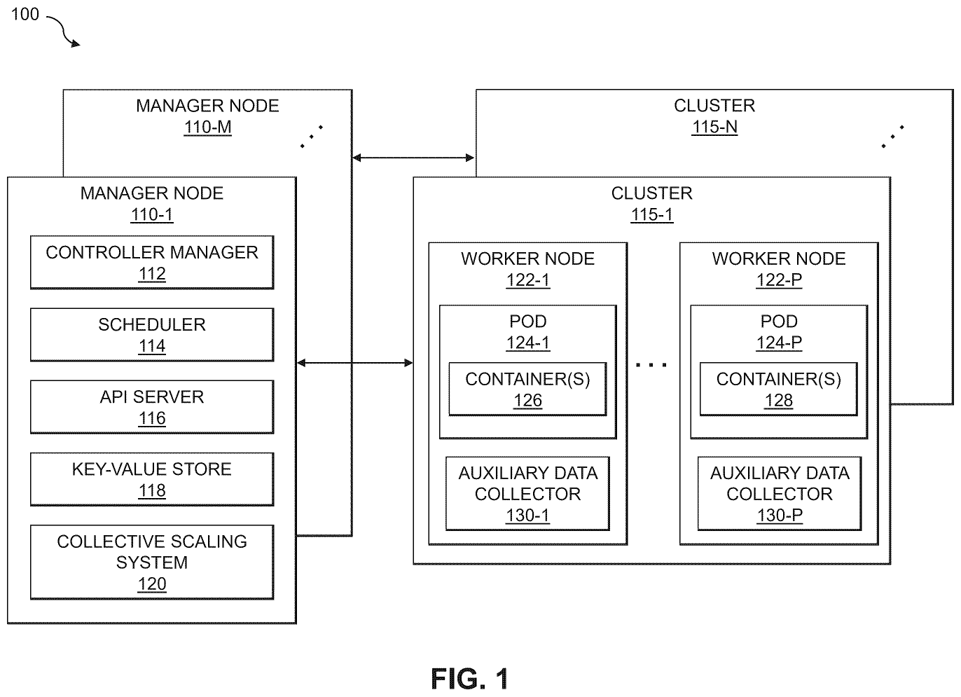

In illustrative embodiments, containers may be implemented using a container-based orchestration system, such as a Kubernetes container orchestration system. Kubernetes is an open-source system for automating application deployment, scaling, and management within a container-based information processing system comprised of components referred to as pods, nodes, and clusters, as will be further explained below in the context of FIG. 1. In at least some embodiments, horizontal scaling techniques increase a number of pods as a load (e.g., a number of requests) increases, while vertical scaling techniques assign more resources to existing pods as the load increases.

Types of containers that may be implemented or otherwise adapted within a Kubernetes system include, but are not limited to, Docker containers or other types of Linux containers (LXCs) or Windows containers. Kubernetes has become a prevalent container orchestration system for managing containerized workloads. It is rapidly being adopted by many enterprise-based information technology (IT) organizations to deploy their application programs (applications). By way of example only, such applications may include stateless (or inherently redundant applications) and/or stateful applications. Non-limiting examples of stateful applications may include legacy databases such as Oracle, MySQL, and PostgreSQL, as well as other stateful applications that are not inherently redundant. While the Kubernetes container orchestration system is used to illustrate various embodiments, it is to be understood that alternative container orchestration systems can be utilized.

Generally, for a Kubernetes environment, one or more containers are part of a pod. Thus, the environment may be referred to, more generally, as a container-based system, pod-based system, a pod-based container system, a pod-based container orchestration system, a pod-based container management system, or the like. Furthermore, a pod is typically considered the smallest execution unit in the Kubernetes container orchestration environment. A pod encapsulates one or more containers, and one or more pods can be executed on a worker node. Multiple worker nodes form a cluster. A Kubernetes cluster is managed by at least one manager node. A Kubernetes environment may include multiple clusters respectively managed by multiple manager nodes. Furthermore, pods typically represent the respective processes running on a cluster. A pod may be configured as a single process wherein one or more containers execute one or more functions that operate together to implement the process. Pods may each have a unique Internet Protocol (IP) address enabling pods to communicate with one another, and for other system components to communicate with each pod. Also, pods may each have persistent storage volumes associated therewith. Configuration information (e.g., configuration objects) indicating how a container executes can be specified for each pod.

FIG. 1 depicts an example of a container-based orchestration environment 100 in an illustrative embodiment. In the example shown in FIG. 1, a plurality of manager nodes 110-1, . . . 110-M (herein each individually referred to as a manager node 110 or collectively as manager nodes 110) are operatively coupled to a plurality of clusters 115-1, . . . 115-N (herein each individually referred to as a cluster 115 or collectively as clusters 115). As mentioned above, each cluster 115 is managed by at least one manager node 110.

Each cluster 115 comprises a plurality of worker nodes 122-1, . . . 122-P (herein each individually referred to as a worker node 122 or collectively as worker nodes 122). Each worker node 122 comprises a respective pod, i.e., one of a plurality of pods 124-1, . . . 124-P (herein each individually referred to as a pod 124 or collectively as pods 124). However, it is to be understood that one or more worker nodes 122 can execute multiple pods 124 at a time. Each pod 124 comprises a set of containers (e.g., containers 126 and 128). It is noted that each pod 124 may also have a different number of containers. As used herein, a pod may be referred to more generally as a containerized workload.

As also shown in FIG. 1, manager node 110-1 comprises a controller manager 112, a scheduler 114, an application programming interface (API) server 116, a key-value store 118, and a collective scaling system 120. It is to be appreciated that in some embodiments, multiple manager nodes 110 may share one or more of the same controller manager 112, scheduler 114, API server 116, key-value store 118, and/or collective scaling system 120. It is to be appreciated that the other manager nodes 110 can be implemented in a similar manner as manager node 110-1.

Worker nodes 122 of each cluster 115 execute one or more applications associated with pods 124 (containerized workloads). Each manager node 110 manages the worker nodes 122, and therefore pods 124 and containers 126, 128, in its corresponding cluster 115. More particularly, each manager node 110 controls operations in its corresponding cluster 115 utilizing the above-mentioned components, e.g., controller manager 112, scheduler 114, API server 116, and key-value store 118. In general, controller manager 112 executes control processes (e.g., controllers) that are used to manage operations in cluster 115. Scheduler 114 typically schedules pods to execute on particular worker nodes 122 taking into account node resources and application execution requirements such as, but not limited to, deadlines. In general, in a Kubernetes implementation, API server 116 exposes the Kubernetes API, which is the front end of the Kubernetes container orchestration system. Key-value store 118 typically provides key-value storage for all cluster data including, but not limited to, configuration data objects generated, modified, deleted, and otherwise managed, during the course of system operations. In the example shown in FIG. 1, worker nodes 122 of each cluster comprise respective auxiliary data collectors 130-1, . . . 130-P (herein each individually referred to as an auxiliary data collector 130 or collectively as auxiliary data collectors 130). The auxiliary data collectors 130 in some examples can be implemented as sidecar applications for collecting usage data, as explained in more detail elsewhere herein.

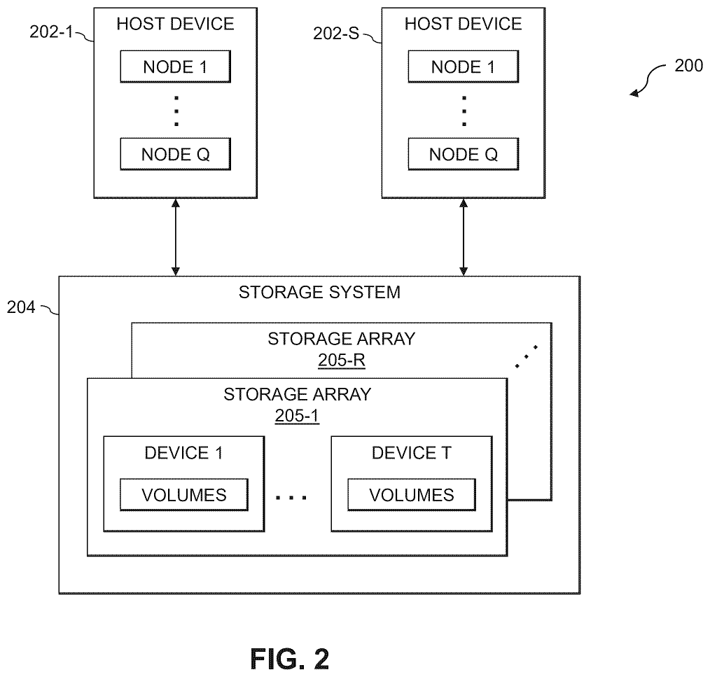

Turning now to FIG. 2, an information processing system 200 is depicted within which the container-based orchestration environment 100 of FIG. 1 can be implemented. More particularly, as shown in FIG. 2, a plurality of host devices 202-1, . . . 202-S (herein each individually referred to as a host device 202 or collectively as host devices 202) are operatively coupled to a storage system 204. Each host device 202 hosts a set of nodes 1, . . . Q. Note that while multiple nodes are illustrated on each host device 202, a host device 202 can host a single node, and one or more host devices 202 can host a different number of nodes as compared with one or more other host devices 202.

As further shown in FIG. 2, storage system 204 comprises a plurality of storage arrays 205-1, . . . 205-R (herein each individually referred to as a storage array 205 or collectively as storage arrays 205), each of which is comprised of a set of storage devices 1, . . . T upon which one or more storage volumes are persisted. The storage volumes depicted in the storage devices of each storage array 205 can include any data generated in the information processing system 200 but, more typically, include data generated, manipulated, or otherwise accessed, during the execution of one or more applications in the nodes of host devices 202. One or more storage arrays 205 may comprise a different number of storage devices as compared with one or more other storage arrays 205.

Furthermore, any one of nodes 1, . . . Q on a given host device 202 can be a manager node 110 or a worker node 122 (FIG. 1). In some embodiments, a node can be configured as a manager node for one execution environment and as a worker node for another execution environment. Thus, the components of container-based orchestration environment 100 in FIG. 1 can be implemented on one or more of host devices 202, such that data associated with pods 124 (FIG. 1) running on the nodes 1, . . . Q is stored as persistent storage volumes in one or more of the storage devices 1, . . . T of one or more of storage arrays 205.

Host devices 202 and storage system 204 of information processing system 200 are assumed to be implemented using at least one processing platform comprising one or more processing devices each having a processor coupled to a memory. Such processing devices can illustratively include particular arrangements of compute, storage, and network resources. In some alternative embodiments, one or more host devices 202 and storage system 204 can be implemented on respective distinct processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of information processing system 200 are possible, in which certain components of the system reside in one data center in a first geographic location while other components of the system reside in one or more other data centers in one or more other geographic locations that are potentially remote from the first geographic location. Thus, it is possible in some implementations of information processing system 200 for portions or components thereof to reside in different data centers. Numerous other distributed implementations of information processing system 200 are possible. Accordingly, the constituent parts of information processing system 200 can also be implemented in a distributed manner across multiple computing platforms.

Additional examples of processing platforms utilized to implement containers, container environments, and container management systems in illustrative embodiments, such as those depicted in FIGS. 1 and 2, will be described in more detail below in conjunction with additional figures.

It is to be appreciated that these and other features of illustrative embodiments are presented by way of example only, and should not be construed as limiting in any way.

Accordingly, different numbers, types and arrangements of system components can be used in other embodiments. Although FIG. 2 shows an arrangement wherein host devices 202 are coupled to just one plurality of storage arrays 205, in other embodiments, host devices 202 may be coupled to and configured for operation with storage arrays across multiple storage systems similar to storage system 204. The functionality associated with the elements 112, 114, 116, 118, and/or 120 in other embodiments can also be combined into a single element, or separated across a larger number of elements. As another example, multiple distinct processors can be used to implement different ones of the elements 112, 114, 116, 118, and/or 120 or portions thereof.

At least portions of elements 112, 114, 116, 118, and/or 120 may be implemented at least in part in the form of software that is stored in memory and executed by a processor.

It should be understood that the particular sets of components implemented in information processing system 200 as illustrated in FIG. 2 are presented by way of example only. In other embodiments, only subsets of these components, or additional or alternative sets of components, may be used, and such components may exhibit alternative functionality and configurations. Additional examples of systems implementing container-based management functionality will be described below.

Still further, information processing system 200 may be part of a public cloud infrastructure. The cloud infrastructure may also include one or more private clouds and/or one or more hybrid clouds (e.g., a hybrid cloud is a combination of one or more private clouds and one or more public clouds).

As mentioned above, a Kubernetes pod may be referred to more generally herein as a containerized workload. One example of a containerized workload is an application program configured to provide a microservice. A microservice architecture is a software approach wherein a single application is composed of a plurality of loosely-coupled and independently-deployable smaller components or services.

Container-based microservice architectures have changed the way development and operations teams test and deploy modern software. Containers make it easier to scale and deploy applications. The pod brings the containers together and makes it easier to scale and deploy applications. Kubernetes clusters allow containers to execute across multiple machines and environments: including virtual, physical, cloud-based and/or on-premises environments. As shown and described above in the context of FIG. 1, Kubernetes clusters are generally comprised of one manager (master) node and one or more worker nodes. These nodes can be physical computers or virtual machines, depending on the cluster. Typically, a given cluster is allocated a fixed number of resources (e.g., CPU, memory, and/or other computer resources), and when a container is defined the number of resources from among the resources allocated to the cluster is specified for the defined container. When the container starts executing, pods are created on the deployed container that will serve the incoming requests.

Some container-based systems are configured to support autoscaling capabilities. For example, a horizontal pod autoscaler (HPA) can automatically adjust a replica count (corresponding to a number of copies of a pod being executed at a given time) based on one or more performance metrics (such as CPU utilization or request rates, as non-limiting examples). Increasing the number of pod replicas helps distribute the load across multiple instances. Vertical scaling is also possible. Vertical scaling increases resources (e.g., CPU, memory, and/or other resources) allocated to one or more existing pods.

For example, Kubernetes enables a multi-cluster environment by sharing and abstracting the underlying compute, network, and storage physical infrastructure, e.g., as illustrated and described above in the context of FIG. 2. With shared compute, storage and/or network resources, the nodes are enabled and added to the Kubernetes cluster. The pod network allows identification of the pod across the network with PodIPs, for example. With this cluster, a pod can execute in any node and scale based on a replica set. The number of pods needed to execute for a given cluster can be defined using the replica set. When the container loads, the defined number of pods will be loaded for that service. A larger number of pods means a larger resource allocation. The amount of memory and CPU that the container can use for a cluster and a pod can also be defined.

If the load of a microservice in a given cluster increases, then the container generally will continue to spin (e.g., add) additional pods to support the increased load. If the container fails due to insufficient resources, all microservices in that container will become unresponsive. In such instances, the container will need to be restarted, and/or additional resources allocated to the container. The pending requests for the microservices in that container will also be lost.

Conventional container-based systems generally perform autoscaling at the service level and do not account for scaling at the feature group level. Features generally represent an expected performance of the system within an acceptable timeframe. The scalability of microservices can be determined by service-level scaling capabilities in one or more embodiments. Enterprise systems often include a collection of interconnected microservices (referred to herein as a “feature group”). As a non-limiting example, a feature group may include interconnected microservices that are used for an order processing application. In such an example, the interconnected microservices can include, for example, an order validation service, a product validation service, a price validation service, a payment processing microservice, etc.

In some examples, each microservice in a feature group can adhere to the Single Responsibility Principle (SRP). The SRP ensures that each microservice has a single, well-defined responsibility (or function). Although adhering to the SRP is often suitable for smaller-scale applications, it may not be adequate for larger and/or more complex systems, which can benefit from scaling at the feature group level.

Performance metrics are typically collected for data related to external requests and responses, which often ignores the network of internal calls within the domain context. Many systems (including enterprise-level systems) frequently rely on inter-domain internal calls, making effective scaling more challenging. For example, usage data is typically collected at the service call level, which generally relates to request and response data between services, but this lacks information regarding the weight or significance of internal calls. It may be beneficial to consider factors, such as the number of connections involved, in addition to response times. Scaling operations are typically triggered reactively in response to resources running low, without monitoring or resolving resource inefficiencies.

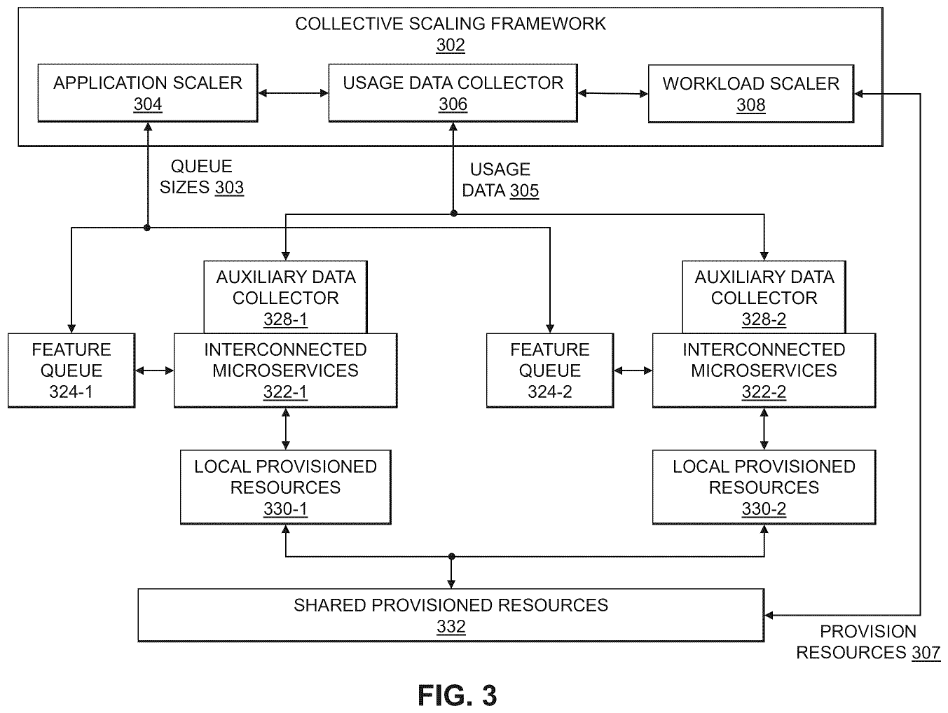

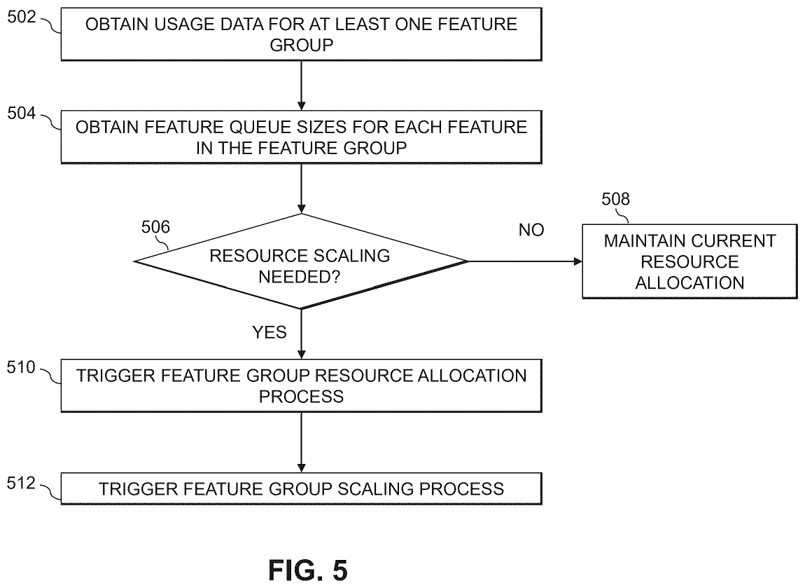

FIG. 3 illustrates a collective scaling framework according to an illustrative embodiment. More particularly, the system architecture comprises a plurality of elements, illustratively interconnected as shown. The elements can be configured to implement a scaling process, such as the process described in conjunction with FIG. 5.

The example shown in FIG. 3 includes collective scaling framework 302 (e.g., corresponding to collective scaling system 120), and interconnected microservices 322-1 and 322-2. In some embodiments, the interconnected microservice 322-1 can correspond to a first feature group, and the interconnected microservices 322-2 can correspond to a second feature group. It should be appreciated that there may be a different numbers of feature groups in other embodiments.

Additionally, the interconnected microservices 322-1 and 322-2 are associated with respective feature queues 324-1 and 324-2 (collectively feature queues 324) and with a respective auxiliary data collector 328-1 and 328-2 (collectively auxiliary data collectors 328). In this example, the interconnected microservices 322-1 and 322-2 are assumed to execute using respective local provisioned resources 330-1 and 330-2 from a pool of shared provisioned resources 332. For example, the shared provisioned resources 332 can correspond to resources that are available at a cluster level, which can be provisioned to the respective local provisioned resources 330-1 and 330-2 based on scaling demand. When scaling down, resources (e.g., from the local provisioned resources 330-1 and 330-2) can be added back to the shared provisioned resources 332.

The collective scaling framework 302 includes an application scaler 304 that adjusts queue sizes 303 of the feature queues 324, a usage data collector 306 for collecting usage data 305 from the auxiliary data collectors 328, and a workload scaler 308 for instantiating and scaling workloads at the feature level.

The application scaler 304 generally controls sizes of the feature queues 324 for features of the interconnected microservices 322. For example, the queue sizes can be based on the average processing time of a given feature. In some embodiments, the workload scaler 308 obtains current processing metrics from usage data collector 306 for each feature group to ensure service workloads are instantiated and scaled in accordance with the feature queues 324 as defined through the application scaler 304. This can help facilitate that the microservice instances are scaled at the feature level. The application scaler 304 can provision resources 307 to the pool of shared provisioned resources 332. Feature scaling can be performed, in some embodiments, for feature groups such that processes are executed with an efficient number of resources and service instances.

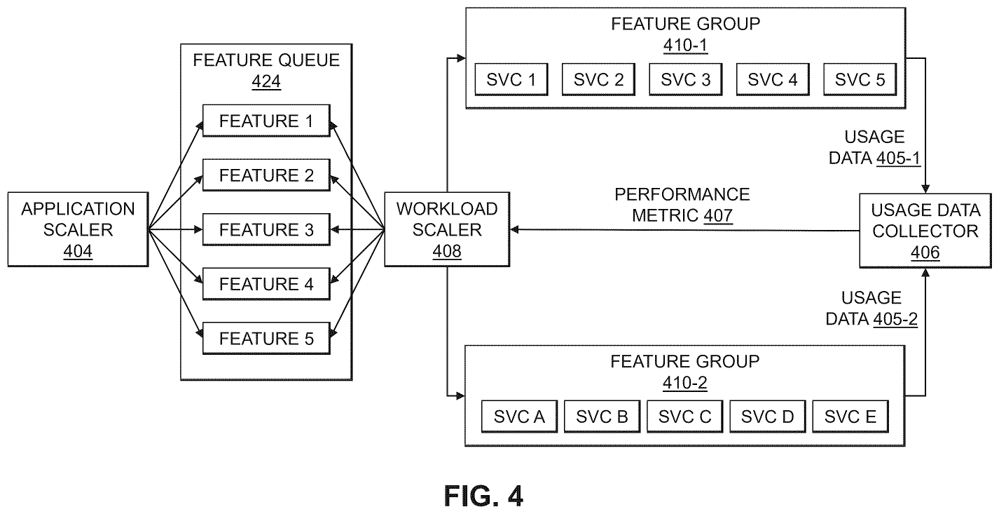

FIG. 4 illustrates an example of a feature queue that is used for collectively scaling feature groups in an illustrative embodiment. More specifically, FIG. 4 shows an example of a feature queue 424 for five features (denoted as features 1 to 5). In this embodiment, a usage data collector 406 collects usage data 405-1 from a feature group 410-1 and usage data 405-2 from a feature group 410-2. In this example, each of the feature groups 410-1, 410-2 comprise five services (labeled SVC 1 to SVC 5 and SVC A to SVC E, respectively). The usage data may include information related to average processing time, CPU usage, memory usage, and/or other types of performance metrics over a given time period. The usage data collector 406 can compute at least one performance metric 407 based on the collected usage data 405-1 and 405-2, and send the at least one performance metric 407 to a workload scaler 408 for initiating and scaling workloads. In some embodiments, the at least one performance metric 407 can indicate a number of transactions over a given time period for each of the services.

An application scaler 404 and the workload scaler 408 can coordinate the feature queue 424 and allocate resources to given features. More specifically, the application scaler 404 can determine at least one feature that is underperforming within the processing pipeline relative to the other features based on one or more designated performance criteria. The term “designated performance criteria” as used herein is intended to be broadly construed so as to encompass, for example, one or more rules and/or one or more thresholds for evaluating a performance of features in a feature group. In at least some embodiments, the designated performance criteria can include identifying one or more microservices in a feature group that are performing at a lower level than other microservices in the feature group. As a non-limiting example, the designated performance criteria can identify at least one microservice in a feature group having the slowest average processing time.

The application scaler 404 can then dynamically adjust a set of feature queue sizes based on the underperforming feature. Optionally, this process can be reversed to obtain information related to amounts of resources needed for different system loads. In at least some embodiments, the information can be provided to one or more users, such as one or more system administrators) via a resource planning dashboard for forecasting possible loads and resources for one or more future time periods.

The application scaler 404 can perform this process periodically (e.g., every five minutes). The feature queue sizes function as a feeder to the given feature on what they must process at any given time based on the collected usage data 405-1 and 405-2. This can help reduce bottlenecks and/or waiting times in the features within the processing pipeline.

In at least some embodiments, the application scaler 404 can derive the feature queue size for a given feature based on the following formula, where sf represents the slowest feature, tps represents a number of transaction per second, fqs₁ represents the feature queue size using a traditional scaling framework, fqs₂ represents an optimized feature queue size using the collective scaling framework, pt represents processing time, and rs % represents a percentage of resources saved between fqs₁ and fqs₂:

$${fps}_{1} = tps \times p t$$

The rs % that is saved in a given feature group can be used for another feature group where resources are needed. In this way, resources can be efficiently reallocated to bring balance between multiple feature groups.

The workload scaler 408, in some embodiments, ensures that the services of a given one of the feature groups 410 are instantiated and scaled appropriately. For example, the workload scaler 408 can obtain the metrics feed from the usage data collector 406, as well as the feature queue size that is set by the application scaler 404. In some embodiments, the workload scaler 408 compares the current operating metrics from the usage data collector 406 to evaluate whether scaling should be performed to satisfy the feature queue sizes, as discussed further below in conjunction with FIG. 5, for example.

FIG. 5 shows a process flow diagram for scaling workloads, in an illustrative embodiment. The process depicted in FIG. 5 is assumed to be performed at least in part by the workload scaler 408.

Step 502 includes obtaining usage data for at least one feature group. Step 504 includes obtaining feature queue sizes (e.g., computed by the application scaler 404) for each feature in the feature group. Step 506 includes a test to check whether resource scaling is needed. If not, then the current resource configuration is maintained as shown at step 508. If the result of step 506 is yes, then step 510 is performed, which includes triggering a feature group resource allocation process. Step 512 includes triggering a feature group scaling process.

In some embodiments, the feature group resource allocation process and the feature group scaling process can be performed based at least in part on a machine learning model. As an example, a machine learning model can be used to determine resource allocations (e.g., an optimal resource allocation configuration) and limits for performing scaling at the feature group level based on collected usage data (e.g., usage data 305).

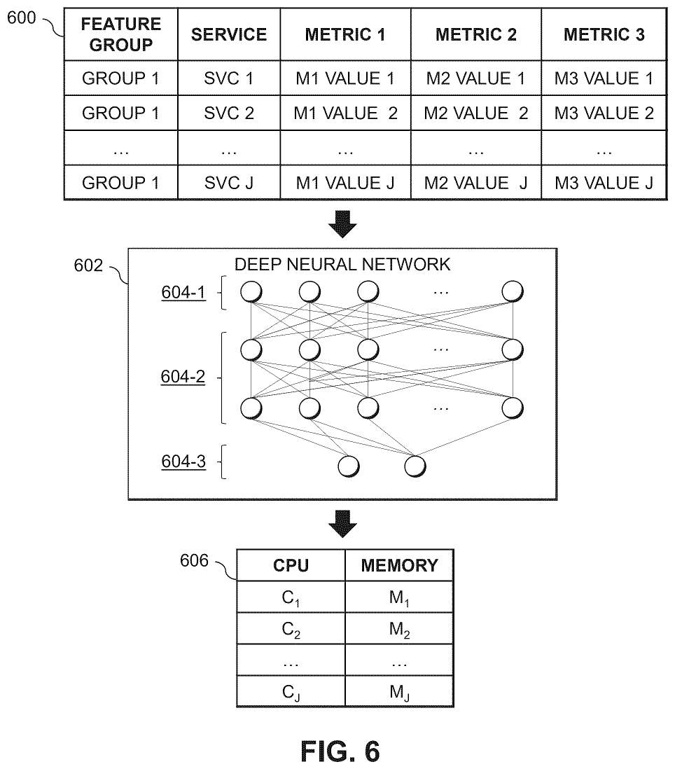

FIG. 6 shows a diagram of a machine learning model architecture for allocating resources, in an illustrative embodiment. In this example, the machine learning model architecture includes a deep neural network 602 that includes an input layer 604-1, a set of hidden layers 604-2, and an output layer 604-3. A set of metrics data 600 (e.g., usage data 305) is provided to the deep neural network 602. The set of metrics data 600 includes three metrics (metrics 1 through 3) for a given feature group (e.g., feature group 1) having multiple services (denoted SVC 1 through SVC J). The performance metrics can include, for example, CPU resources allocated, CPU resources used, memory resources allocated, memory resources used, average response times, a number of HTTP requests, and/or other types of performance or utilization metrics. The input layer 604-1 corresponds to the current performance metrics (which can be referred to as X), and the set of hidden layers 604-2 receives the features (X) from the input layer. In the example shown in FIG. 6, the set of hidden layers 604-2 comprises two layers, but it is to be appreciated that there may be more hidden layers in other embodiments.

Consider an example where the first hidden layer includes eight neurons that process the input features using weights and biases. Each neuron can comprise a weight (denoted W1) and a bias term (denoted b1). For each neuron, the weighted sum (Z1) of input features, combined with its corresponding weights, can be computed as: Z1=W1*X+b1.

The output of the weighted sum (Z1) is processed through a Rectified Linear Unit (ReLU) activation function to replace negative values with zeros, which can be expressed as: A1=ReLU(Z1), where A1 represents the output of the first hidden layer.

The output of the first hidden layer is provided as an input to the second hidden layer. Similar to the first hidden layer, each neuron in the second layer includes a weight (W2) and a bias term (b2). The weighted sum (Z2) of the inputs from the first hidden layer and their corresponding weights can be computed as: Z2=W2*A1+b2. The weighted sum (Z2) is passed through the ReLU activation function, which can be expressed as: A2=ReLU(Z2), where A2 represents the output of the second hidden layer.

The output layer 604-3 can generate resource predictions (e.g., CPU and memory resource allocations as shown in table 606). Each neuron in the output layer 604-3 has its own weight (W3, W4) and bias term (b3, b4) for the hidden layer output A1 and A2.

A first neuron in the output layer 604-3 can correspond to a first resource prediction (e.g., CPU resource allocation, denoted as Cₓ). As an example, the first resource prediction, Cₓ, can be computed as Cₓ=SoftPlus(Z3), where Z3=W3*A1+b3.

A second neuron of the output layer 604-3 can be used to predict the memory resource allocation (denoted as Mₓ), using a similar approach to the first neuron. For example, the second neuron can be expressed as follows: Mₓ=SoftPlus(Z4), where Z4 is a weighted sum computed as Z4=W4*A2+b4. The parameters Cₓ and Mₓ can be derived for all services in the given feature group.

In some embodiments, the feature group scaling process at step 512 can predict one or more scaling limits (e.g., an optimal minimum limit and/or optimal maximum limit) to be used in an automated scaling process (e.g., an HPA process) of a container-based system such that the scaling can be performed for each microservice that is part of a given feature group. In some embodiments, the scaling limits can be derived by extending the deep neural network depicted in FIG. 6.

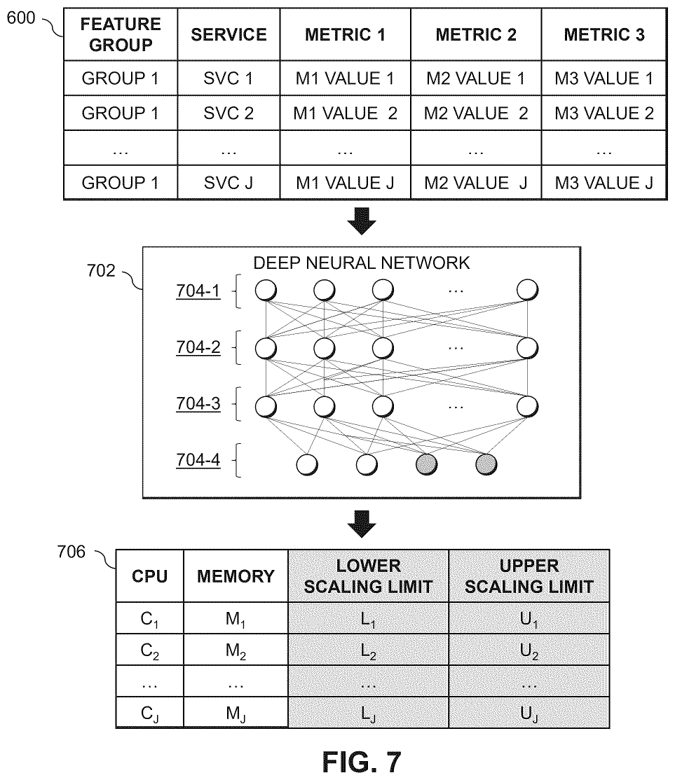

FIG. 7 shows a diagram of an extended machine learning model architecture, in an illustrative embodiment. Similar to FIG. 6, the extended machine learning model architecture includes a deep neural network 702 that includes an input layer 704-1, a set of hidden layers 704-2 and 704-3, and an output layer 704-4. The output layer 704-4 includes two additional neurons, relative to the machine learning model architecture of FIG. 6 (as indicated by the shaded circles), which are used to predict lower and upper scaling limits, as indicated by the shaded cells in output table 706. More specifically, the extended output layer 704-3 can include a third neuron having a set of weights W5 and bias b5 for the hidden layer output A3, and a fourth neuron having a set of weights W6 and bias b6 for the hidden layer output A4. The lower scaling limit (denoted MINx) derived by third neuron in the output layer 704-4 can be determined by the following equations:

Z5=W5*A3+b5, where Z5 is a weighted sum,

MIN x=SoftPlus(Z5).

The upper scaling limit (denoted MAXx) derived by the fourth neuron in the output layer 704-5 can be determined by the following equations:

Z6=W6*A4+b6, where Z6 is a weighted sum,

MAX x=SoftPlus(Z6).

The predicted MINx and MAXx scaling limits can be applied to each service in a feature group to apply adaptive scaling at the feature group level.

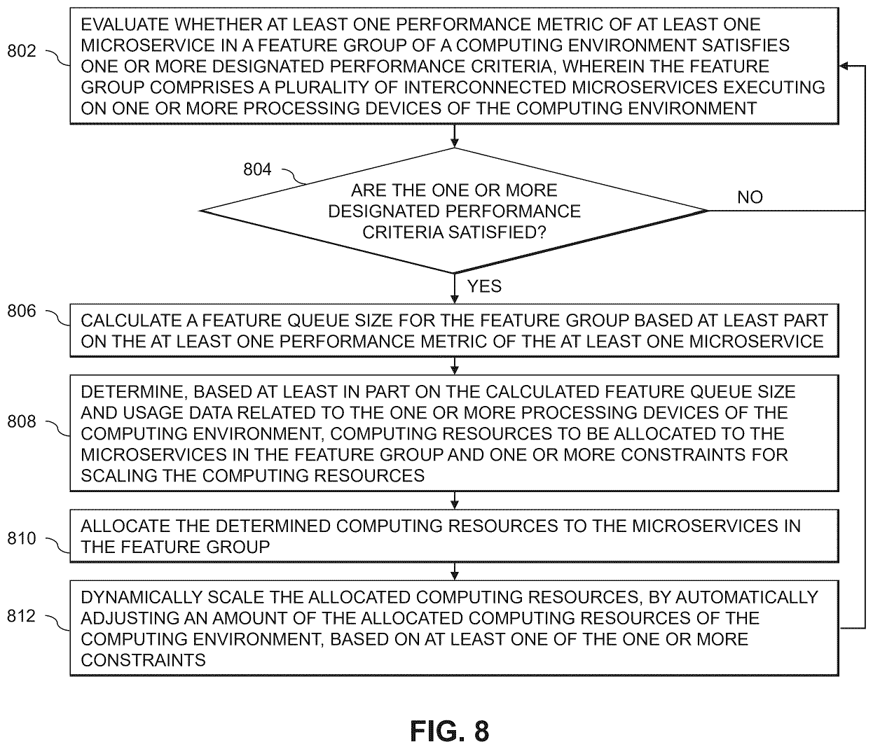

FIG. 8 is a flow diagram of a process for collective scaling for computing environments in an illustrative embodiment. It is to be understood that this particular process is only an example, and additional or alternative processes can be carried out in other embodiments.

In this embodiment, the process includes steps 802 through 812. These steps are assumed to be performed at least in part by the collective scaling system 120.

Step 802 includes evaluating whether at least one performance metric of at least one microservice in a feature group of a computing environment satisfies one or more designated performance criteria, wherein the feature group comprises a plurality of interconnected microservices executing on one or more processing devices of the computing environment.

Step 804 includes a test that checks whether the one or more designated performance criteria are satisfied for the at least one microservice. If yes, then steps 806-812 are performed. Otherwise, the process returns to step 802.

Step 806 includes calculating a feature queue size for the feature group based at least part on the at least one performance metric of the at least one microservice.

Step 808 includes determining, based at least in part on the calculated feature queue size and usage data related to the one or more processing devices of the computing environment, computing resources to be allocated to the microservices in the feature group and one or more constraints for scaling the computing resources.

Step 810 includes allocating the determined computing resources to the microservices in the feature group.

Step 812 includes dynamically scaling the allocated computing resources, by automatically adjusting an amount of the allocated computing resources of the computing environment, based on at least one of the one or more constraints. The process may then return to step 802 to continue to evaluate the at least one performance metric.

The one or more constraints may include a low scaling threshold and a high scaling threshold for at least a given microservice in the feature group. The plurality of interconnected microservices may be executed by the one or more processing devices using a plurality of containers, and the usage data may be obtained from one or more auxiliary applications associated with at least a portion of the plurality of containers. The determining the computing resources to be allocated to the microservices may include processing at least a portion of the usage data by a machine learning model that is trained to predict the computing resources based at least in part on historical usage data. The machine learning model may be further trained to predict the one or more constraints for dynamically scaling the allocated computing resources. Dynamically scaling the allocated computing resources may include configuring a horizontal automatic scaling component with the one or more constraints. The computing resources may include at least one of memory resources and processing resources. The process may further include a step of periodically recalculating the feature queue size. The process may be performed for multiple feature groups of the computing environment. The at least one performance metric may correspond to an average processing time. The one or more designated performance criteria may include determining whether the at least one microservice has a longer processing time than at least one other microservice in the feature group.

Accordingly, the particular processing operations and other functionality described in conjunction with the flow diagram of FIG. 8 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional techniques. For example, some embodiments are configured to significantly improve the scalability of microservices by implementing a collective scaling framework that scales workloads at the feature group level, rather than just at the service level. Such embodiments can help ensure that features within a processing pipeline are loaded evenly and with an efficient number of resources, thereby reducing bottlenecks and processing times. Additionally, some embodiments can obtain usage data from application containers, which can be used to initiate and scale workloads at the feature group level based on one or more performance metrics. Accordingly, services within a given feature group can be instantiated and scaled appropriately in response to changing resource demands, thereby improving utilization of resources, and helping ensure that applications satisfy quality of service thresholds, for example. Furthermore, some embodiments utilize machine learning models to determine optimum resources requests and limits at the feature group level based on the collected usage data. These and other embodiments can effectively overcome problems associated with conventional container-based systems that require one or more of: manual scaling, service-level scaling only, and/or inflexible resource allocations.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the container-based orchestration environment 100 and/or information processing system 200 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the container-based orchestration environment 100 and/or information processing system 200. For example, containers can be used to implement respective processing devices providing compute and/or storage services of a cloud-based system. Again, containers may be used in combination with other virtualization infrastructure such as virtual machines implemented using a hypervisor.

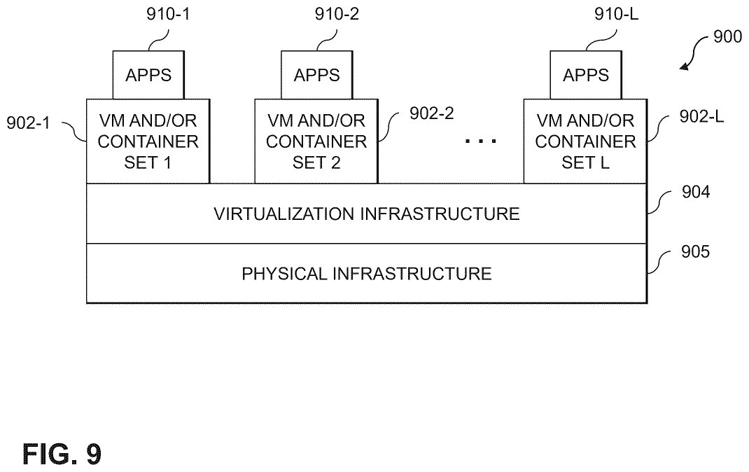

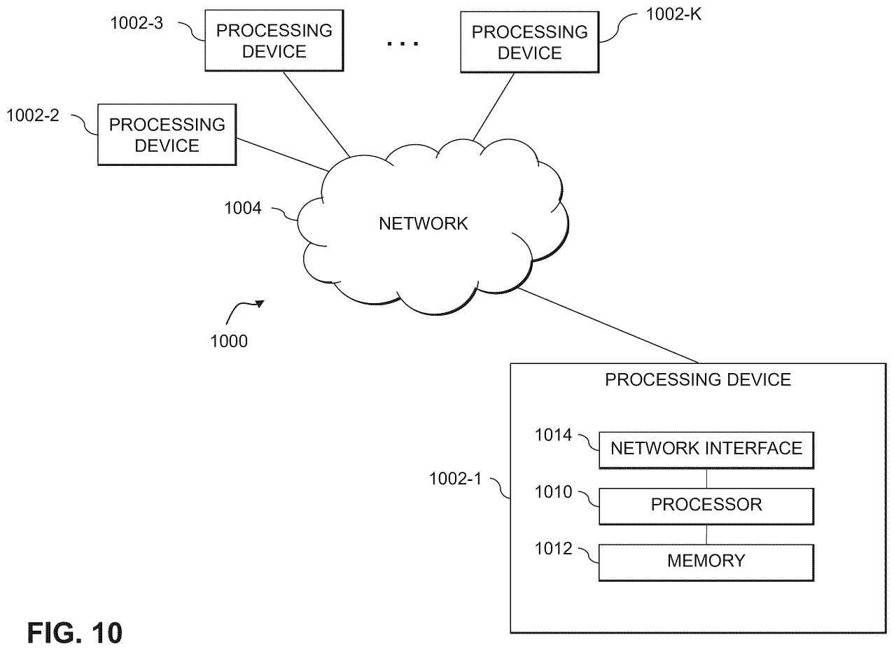

Illustrative embodiments of processing platforms will now be described in greater detail with reference to FIGS. 9 and 10. Although described in the context of container-based orchestration environment 100 and/or information processing system 200, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the container-based orchestration environment 100 and/or information processing system 200. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, wherein the hypervisor platform has an associated virtual infrastructure management system. The underlying physical machines comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of container-based orchestration environment 100 and/or information processing system 200 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system container-based orchestration environment 100 and/or information processing system 200 and includes a plurality of processing devices, denoted 1002-1, 1002-2, 1002-3, . . . 1002-K, which communicate with one another over a network 1004.

The processing device 1002-1 in the processing platform 1000 comprises a processor 1010 coupled to a memory 1012 and a network interface 1014.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory 1012 comprises random access memory (RAM), read-only memory (ROM) or other types of memory, in any combination. The memory 1012 and other memories disclosed herein should be viewed as illustrative examples of what are more generally referred to as “processor-readable storage media” storing executable program code of one or more software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and container-based orchestration environment 100 and/or information processing system 200 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the container-based orchestration environment 100 and/or information processing system 200. Such components can communicate with other elements of the container-based orchestration environment 100 and/or information processing system 200 over any type of network or other communication media.

For example, particular types of storage products that can be used in implementing a given storage system of a distributed processing system in an illustrative embodiment include network-attached storage (NAS), storage area networks (SANs), direct-attached storage (DAS) and distributed DAS, as well as combinations of these and other storage types, including software-defined storage.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
evaluating whether at least one performance metric of at least one microservice in a feature group of a computing environment satisfies one or more designated performance criteria, wherein the feature group comprises a plurality of interconnected microservices executing on one or more processing devices of the computing environment; and
in response to the at least one performance metric of the at least one microservice satisfying the one or more designated performance criteria:
calculating a feature queue size for the feature group based at least part on the at least one performance metric of the at least one microservice;
determining, based at least in part on the calculated feature queue size and usage data related to the one or more processing devices of the computing environment, computing resources to be allocated to the microservices in the feature group and one or more constraints for scaling the computing resources;
allocating the determined computing resources to the microservices in the feature group; and
dynamically scaling the allocated computing resources, by automatically adjusting an amount of the allocated computing resources of the computing environment, based on at least one of the one or more constraints;
wherein the method is performed by at least one processing device comprising a processor coupled to a memory.

2. The computer-implemented method of claim 1, wherein the one or more constraints comprise a low scaling threshold and a high scaling threshold for one or more microservices in the feature group.

3. The computer-implemented method of claim 1, wherein the plurality of interconnected microservices is executed by the one or more processing devices using a plurality of containers, and wherein the usage data is obtained from one or more auxiliary applications associated with at least a portion of the plurality of containers.

4. The computer-implemented method of claim 1, wherein the determining the computing resources to be allocated to the microservices comprises:
processing at least a portion of the usage data by a machine learning model that is trained to predict the computing resources based at least in part on historical usage data.

5. The computer-implemented method of claim 4, wherein the machine learning model is further trained to predict the one or more constraints for dynamically scaling the allocated computing resources.

6. The computer-implemented method of claim 1, wherein the dynamically scaling the allocated computing resources comprises:
configuring a horizontal automatic scaling component with the one or more constraints.

7. The computer-implemented method of claim 1, wherein the computing resources comprise at least one of: memory resources and processing resources.

8. The computer-implemented method of claim 1, further comprising periodically recalculating the feature queue size.

9. The computer-implemented method of claim 1, wherein the method is performed for multiple feature groups of the computing environment.

10. The computer-implemented method of claim 1, wherein the at least one performance metric corresponds to an average processing time, and wherein the one or more designated performance criteria comprises determining whether the at least one microservice has a longer processing time than at least one other microservice in the feature group.

11. A non-transitory processor-readable storage medium having stored therein program code of one or more software programs, wherein the program code when executed by at least one processing device causes the at least one processing device:
to evaluate whether at least one performance metric of at least one microservice in a feature group of a computing environment satisfies one or more designated performance criteria, wherein the feature group comprises a plurality of interconnected microservices executing on one or more processing devices of the computing environment; and
in response to the at least one performance metric of the at least one microservice satisfying the one or more designated performance criteria:
to calculate a feature queue size for the feature group based at least part on the at least one performance metric of the at least one microservice;
to determine, based at least in part on the calculated feature queue size and usage data related to the one or more processing devices of the computing environment, computing resources to be allocated to the microservices in the feature group and one or more constraints for scaling the computing resources
to allocate the determined computing resources to the microservices in the feature group; and
to dynamically scale the allocated computing resources, by automatically adjusting an amount of the allocated computing resources of the computing environment, based on at least one of the one or more constraints.

12. The non-transitory processor-readable storage medium of claim 11, wherein the one or more constraints comprise a low scaling threshold and a high scaling threshold for at least a given microservice in the feature group.

13. The non-transitory processor-readable storage medium of claim 11, wherein the plurality of interconnected microservices is executed by the one or more processing devices using a plurality of containers, and wherein the usage data is obtained from one or more auxiliary applications associated with at least a portion of the plurality of containers.

14. The non-transitory processor-readable storage medium of claim 11, wherein the determining the computing resources to be allocated to the microservices comprises:
processing at least a portion of the usage data by a machine learning model that is trained to predict the computing resources based at least in part on historical usage data.

15. The non-transitory processor-readable storage medium of claim 14, wherein the machine learning model is further trained to predict the one or more constraints for dynamically scaling the allocated computing resources.

16. An apparatus comprising:
at least one processing device comprising a processor coupled to a memory;
the at least one processing device being configured:
to evaluate whether at least one performance metric of at least one microservice in a feature group of a computing environment satisfies one or more designated performance criteria, wherein the feature group comprises a plurality of interconnected microservices executing on one or more processing devices of the computing environment; and
in response to the at least one performance metric of the at least one microservice satisfying the one or more designated performance criteria:
to calculate a feature queue size for the feature group based at least part on the at least one performance metric of the at least one microservice;
to determine, based at least in part on the calculated feature queue size and usage data related to the one or more processing devices of the computing environment, computing resources to be allocated to the microservices in the feature group and one or more constraints for scaling the computing resources;
to allocate the determined computing resources to the microservices in the feature group; and
to dynamically scale the allocated computing resources, by automatically adjusting an amount of the allocated computing resources of the computing environment, based on at least one of the one or more constraints.

17. The apparatus of claim 16, wherein the one or more constraints comprise a low scaling threshold and a high scaling threshold for at least a given microservice in the feature group.

18. The apparatus of claim 16, wherein the plurality of interconnected microservices is executed by the one or more processing devices using a plurality of containers, and wherein the usage data is obtained from one or more auxiliary applications associated with at least a portion of the plurality of containers.

19. The apparatus of claim 16, wherein the determining the computing resources to be allocated to the microservices comprises:
processing at least a portion of the usage data by a machine learning model that is trained to predict the computing resources based at least in part on historical usage data.

20. The apparatus of claim 19, wherein the machine learning model is further trained to predict the one or more constraints for dynamically scaling the allocated computing resources.
